(19) United States
(12) Patent Application Publication
(10) Pub. No.: US 2019/0370826 A1
(43) Pub. Date: Dec. 5, 2019

(54) METHOD AND SYSTEM FOR ANONYMOUS ESTIMATION OF TRANSACTION BASKET DETAILS

(71) Applicant: MASTERCARD INTERNATIONAL INCORPORATED, Purchase, NY (US)

(72) Inventors: Lindsey Azzaretti, Larchmont, NY (US); Anthony John Sanches, Stamford, CT (US); Curtis C. Villars, Chatham, NJ (US); Marianne Iannace, North Salem, NY (US)

(73) Assignee: MASTERCARD INTERNATIONAL INCORPORATED, Purchase, NY (US)

(21) Appl. No.: 15/995,401

(22) Filed: Jun. 1, 2018

(51) Int. Cl. G06Q 30/02; G06F 17/30

(52) U.S. Cl. CPC G06Q 30/0201; G06F 17/30477; G06Q 30/0204

(57) ABSTRACT

A method for identifying spending trends at multi-category merchants includes storing historical transaction data for a plurality of transaction accounts, each transaction account having account attributes associated therewith. Spending amounts are received for a plurality of spend categories for a consumer group having set account attributes. Stored transactional data is identified for those transaction accounts having the same account attributes as the consumer group; then the spending amounts are extrapolated onto the stored transactional data to estimate categorical spending by the related transaction accounts across each of the spend categories, based on the overall transaction amounts and extrapolation of the spending amounts, over a plurality of periods of time. Spending trends are then identified based on changes in the estimated categorical spending over time, enabling trends to be identified on a department-level basis for multi-category merchants where such spending data is unavailable.

### FIELD

The present disclosure relates to the identification of spending trends for consumers at multi-category merchants, specifically the use of microsegments and available transaction data to estimate departmental spending of consumers at a multi-category merchant without the need for product-specific data and while retaining consumer anonymity and privacy.

### BACKGROUND

Merchants, advertisers, retailers, and other entities are often interested in knowing both how and where consumers spend their money. Such information can be useful in a variety of contexts, such as identifying effectiveness of an advertising campaign, figuring out what consumers think of the competition, identifying when consumers are choosing to shop at other merchants, etc. For consumers in niche industries, such information may be relatively easy to come by or figure out. For example, if there are only one or two competitors in that industry, a loss in sales could most likely be attributed directly to the competition. However, for merchants dealing with more common goods, it may be considerably more difficult to identify trends related to spending.

The difficulty is increased even more when multi-category merchants are involved. For these types of merchants, such as WalMart® or Amazon®, it is often difficult, if not impossible, to tell how a consumer spent their money at such a merchant. Thus, a consumer may be spending less on goods at a specialized merchant in a common industry, such as cosmetics, but it may be impossible to tell from the consumer's transaction history if the consumer was instead shopping at a multi-category merchant or just refraining from spending on cosmetics as a whole. Such information may be incredibly valuable to merchants, advertisers, and other entities. However, current systems are unable to identify such information and trends in spending. Existing systems lack the knowledge and ability of what type of data must be gathered and how that data must be analyzed and manipulated, and what data it should be applied to, in order to make identifications that are useful and effective for interested parties.

Thus, there is a need for a technological solution for being able to identify trends in spending at multi-category merchants using additional data sources outside of any detailed knowledge for the multi-category merchant itself.

### SUMMARY

The present disclosure provides a description of systems and methods for identifying spending trends at multi-category merchants. Transactional data is gathered from one or more merchants that can illustrate the spending of a group of consumers across multiple departments, such as by the merchants themselves being aligned to specific departments or the availability of product- or department-level data at these merchants. Available spending data for multi-category merchants is identified, and the gathered transactional data applied to the spending data to extrapolate estimations of spending at the multi-category merchants over various periods of time. This is then used to identify trends in spending, such as by identifying upticks in spending in a specific department at a multi-category merchant that corresponds to reduced spending at an industry-specific merchant around the same period of time. Such information can also be used to forecast future trends and activity for specific departments, both for specialized retailers and at multi-category merchants. The use of microsegments and transactional data that may not be account-specific can ensure that such useful data is identified without compromising consumer security or privacy, and may even be done without the use of any personally identifiable information, making the methods discussed herein in compliance with even the strictest regulations regarding consumer privacy. Thus, the methods and systems discussed herein provide a technological solution to an existing technical problem, and do so while maintaining the highest level of consumer security and privacy.

A method for identifying spending trends at multi-category merchants includes: storing, in an account database of a processing server, a plurality of account profiles, wherein each account profile is related to one or more transaction accounts and includes at least one or more account attributes and a plurality of transaction data entries, where each transaction data entry is related to a processed payment transaction funded by a related transaction account and includes at least a merchant identifier, transaction date, and transaction amount; receiving, by a receiver of the processing server, spending data for a plurality of consumer groups, wherein each consumer group is associated with at least one account attribute and the spending data includes, for each of the plurality of consumer groups, at least a spending amount for the respective consumer group for each of a plurality of spend categories; receiving, by the receiver of the processing server, a trend request, wherein the trend request includes at least a specific consumer group of the plurality of consumer groups; executing, by the processing server, a query on the account database to identify one or more account profiles where the included one or more account attributes corresponds to the at least one account attribute associated with the specific consumer group in the received spending data; identifying, by the processing server, a subset of transaction data entries included in the identified one or more account profiles that includes a specific merchant identifier; estimating, by the processing server, categorical spending for each of the one or more account profiles for each of the plurality of spend categories over a plurality of time periods based on at least application of the spending amount for each of the plurality of spend categories for the specific consumer group to the transaction amount included in the subset of transaction data entries in the respective account profile and the transaction time included in the subset of transaction data entries in the respective account profile; identifying, by the processing server, at least one spending trend for at least one of the one or more account profiles for a spend category of the plurality of spend categories based on a difference of the estimated categorical spending across the plurality of time periods for the respective spend category and account profile; and electronically transmitting, by a transmitter of the processing server, the identified at least one spending trend in response to the received trend request.

A system for identifying spending trends at multi-category merchants includes: an account database of a processing server configured to store a plurality of account profiles, wherein each account profile is related to one or more transaction accounts and includes at least one or more account attributes and a plurality of transaction data entries, where each transaction data entry is related to a processed payment transaction funded by a related transaction account and includes at least a merchant identifier, transaction date, and transaction amount; a receiver of the processing server configured to receive spending data for a plurality of consumer groups, wherein each consumer group is associated with at least one account attribute and the spending data includes, for each of the plurality of consumer groups, at least a spending amount for the respective consumer group for each of a plurality of spend categories, and a trend request, wherein the trend request includes at least a specific consumer group of the plurality of consumer groups; the processing server configured to execute a query on the account database to identify one or more account profiles where the included one or more account attributes corresponds to the at least one account attribute associated with the specific consumer group in the received spending data, identify a subset of transaction data entries included in the identified one or more account profiles that includes a specific merchant identifier, estimate categorical spending for each of the one or more account profiles for each of the plurality of spend categories over a plurality of time periods based on at least application of the spending amount for each of the plurality of spend categories for the specific consumer group to the transaction amount included in the subset of transaction data entries in the respective account profile and the transaction time included in the subset of transaction data entries in the respective account profile, and identify at least one spending trend for at least one of the one or more account profiles for a spend category of the plurality of spend categories based on a difference of the estimated categorical spending across the plurality of time periods for the respective spend category and account profile; and a transmitter of the processing server configured to electronically transmit the identified at least one spending trend in response to the received trend request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for identifying spending trends at multi-category merchants in accordance with exemplary embodiments.

FIG. 2 is a diagram illustrating the identification of spending trends at multi-category merchants based on gathered transactional data and the use of adjustment factors to compensate for changing behaviors in accordance with exemplary embodiments.

FIG. 3 is a block diagram illustrating the processing server of the system of FIG. 1 for identifying spending trends at multi-category merchants in accordance with exemplary embodiments.

FIG. 4 is a flow diagram illustrating a process for identifying spending trends at multi-category merchants as executed by the processing server of FIG. 3 in accordance with exemplary embodiments.

FIG. 5 is a flow chart illustrating an exemplary method for identifying spending trends at multi-category merchants in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Personally identifiable information (PII)—PII may include information that may be used, alone or in conjunction with other sources, to uniquely identify a single individual. Information that may be considered personally identifiable may be defined by a third party, such as a governmental agency (e.g., the U.S. Federal Trade Commission, the European Commission, etc.), a non-governmental organization (e.g., the Electronic Frontier Foundation), industry custom, consumers (e.g., through consumer surveys, contracts, etc.), codified laws, regulations, or statutes, etc. The present disclosure provides for methods and systems where the processing server 102 does not possess any personally identifiable information. Systems and methods apparent to persons having skill in the art for rendering potentially personally identifiable information anonymous may be used, such as bucketing. Bucketing may include aggregating information that may otherwise be personally identifiable (e.g., age, income, etc.) into a bucket (e.g., grouping) in order to render the information not personally identifiable. For example, a consumer of age 26 with an income of $65,000, which may otherwise be unique in a particular circumstance to that consumer, may be represented by an age bucket for ages 21-30 and an income bucket for incomes $50,000 to $74,999, which may represent a large portion of additional consumers and thus no longer be personally identifiable to that consumer. In other embodiments, encryption may be used. For example, personally identifiable information (e.g., an account number) may be encrypted (e.g., using a one-way encryption) such that the processing server 102 may not possess the PII or be able to decrypt the encrypted PII.

Microsegment—A representation of a group of consumers that is granular enough to be valuable to advertisers, marketers, offer providers, merchants, retailers, etc., but still maintain a high level of consumer privacy without the use or obtaining of personally identifiable information. Microsegments may be given a minimum or a maximum size. A minimum size of a microsegment would be at a minimum large enough so that no entity could be personally identifiable, but small enough to provide the granularity needed in a particular circumstance. Microsegments may be defined based on geographical or demographical information, such as age, gender, income, marital status, postal code, income, spending propensity, familial status, etc., behavioral variables, or any other suitable type of data, such as discussed herein. The granularity of a microsegment may be such that behaviors or data attributed to members of a microsegment may be similarly attributable or otherwise applied to consumers having similar characteristics. In some instances, microsegments may be grouped into an audience. An audience may be any grouping of microsegments, such as microsegments having a common data value, microsegments encompassing a plurality of predefined data values, etc. In some instances, the size of a microsegment may be dependent on the application. An audience based on a plurality of microsegments, for instance, might have ten thousand entities, but the microsegments would be aggregated when forming the audience and would not be discernible to anyone having access to an audience. Additional detail regarding microsegments and audiences may be found in U.S. patent application Ser. No. 13/437,987, entitled “Protecting Privacy in Audience Creation,” by Curtis Villars et al., filed on Apr. 3, 2012, which is herein incorporated by reference in its entirety.

### System for Identification of Spending Trends at Multi-Category Merchants

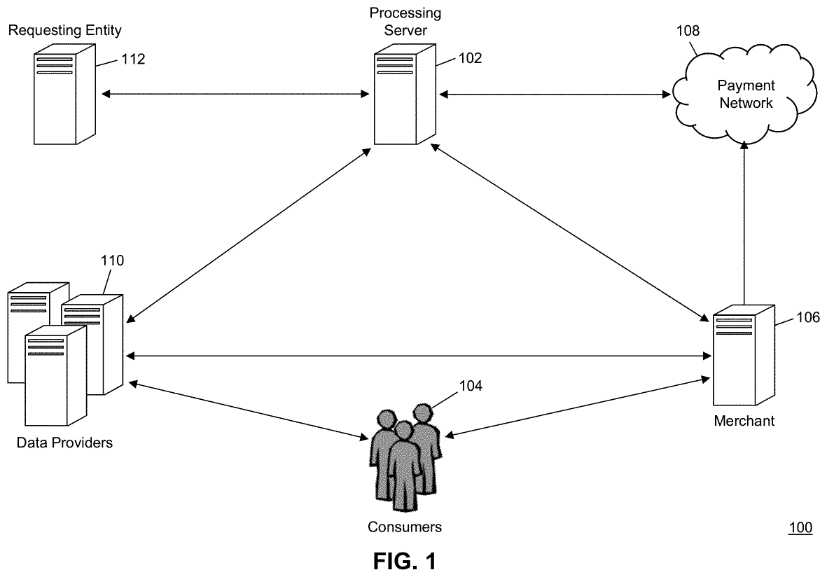

FIG. 1 illustrates a system 100 for the identification of spending trends at multi-category merchants based on available spending data and extrapolation thereof to available transactional data for microsegments of consumers.

The system 100 may include a processing server 102. The processing server 102, discussed in more detail below, may be configured to identify spending trends for consumers at a multi-category merchant, particularly in cases where product- or department-level data may be unavailable for such a merchant. In the system 100, consumers 104 may engage in payment transactions with a merchant 106. The payment transactions may involve the purchase of goods or services from the merchant 106 by each consumer 104, where the payment transactions may be processed by a payment network 108. The payment network 108 may be configured to provide transaction data for the payment transactions involving the merchant 106 and consumers 104 to the processing server 102. In some embodiments, the processing server 102 may be a part of the payment network 108 and may receive the transaction data through internal communications of the payment network 108 and/or during the processing of payment transactions. In other embodiments, the processing server 102 may be external to the payment network 108 and may receive the transaction data via electronic transmissions therefrom. In some such embodiments, the payment network 108 may communicate with the processing server 102 via payment rails associated with the payment network 108 and may, in some cases, provide the transaction data to the processing server 102 in the form of transaction messages used in the processing of the respective payment transactions, where transaction messages may be specially formatted data messages that are formatted according to one or more standards governing the interchange of financial transaction messages, such as the International Organization of Standardization's ISO 8583 or ISO 20022 standards.

The processing server 102 may receive the transaction data and may store the data in suitable storage thereof, discussed in more detail below. The transaction data may include at least a transaction amount, transaction date, and merchant identifier (e.g., associated with the merchant 106 involved in the payment transaction) for each payment transaction. The transaction data may also include or be accompanied by information identifying the consumer 104 involved in the payment transaction or a group of consumers (e.g., a microsegment) to which the transaction data is attributed. For instance, in one case, the transaction data may include a primary account number of a transaction account used to fund the payment transaction, where the transaction account is issued to a specific consumer 104. In another case, transaction data for several transactions may be sent to the processing server 102 where all of the transactions are associated with a specific group of consumers 104. In some embodiments, transaction data that is account-specific may be anonymized such that no personally identifiable information (PII) is included. For example, the primary account number may be hashed or otherwise obscured. Transaction data may also include any additional data associated with a payment transaction that may be used by the processing server 102 in performing the functions discussed herein, such as transaction time, currency type, geographic location, transaction type (e.g., physical, e-commerce, etc.), merchant category code, offer data, reward data, loyalty data, etc.

The processing server 102 may store the transaction data in data storage, as discussed in more detail below. In some embodiments, the transaction data may be stored in a profile associated with a specific transaction account used in the payment transaction. In other embodiments, the transaction data may be stored in a profile associated with a microsegment of consumers 104. Microsegments may be based on any criteria that may be used for the grouping of consumers, including geographic and/or demographic attributes, financial attributes, behavioral attributes, etc. In some cases, one consumer 104 may be a group of multiple microsegments. In an exemplary embodiment, a microsegment may small enough to have statistically significant data while maintaining consumer anonymity, such as a group of ten consumers 104.

In the system 100, the processing server 102 may be configured to receive spending data for a plurality of consumer groups from one or more data providers 110. Data providers 110 may be merchants 106, research groups, data collection agencies, surveying services, receipt analyzing entities, consumers 104, and/or any other entity that may be configured to collect and provide spending data for consumer groups to the processing server 102. Each consumer group may be a microsegment of consumers 104, where the consumer group is associated with one or more account attributes, where each consumer 104 in the consumer group matches the associated account attributes. For instance, a consumer group may be a group of consumers 104 that live in a specific zip code that are of a specific gender and in a specific age group. Consumer groups may be separated using any suitable type of criteria that may go beyond or in addition to geographic and demographic characteristics. In some cases, the processing server 102 may receive spending data from multiple data providers 110, where each data provider 110 may use different account attributes for use in separating consumer groups. The spending data may include at least a spending amount for the consumer group (e.g., aggregated or average, as applicable) for each of a plurality of spend categories. The spend categories may be departments, category codes, or other delineations of consumer spending. In some cases, the spending data may include a spending amount by consumers 104 in the consumer group for multiple merchant departments during a specific period of time, or may include different spending amounts across multiple periods of time. In some embodiments, the spending data may include spending by consumers 104 at a single multi-category merchant 106 for the consumers 104 across each department of the merchant 106. In other embodiments, the spending data may include spending by consumers 104 at different merchants 106, where each merchant 106 is associated with a specific department (e.g., based on merchant category code or other identification information). In some cases, the spending data received from the data providers 110 may indicate if the corresponding transactions are physical transactions or e-commerce or other remote transactions.

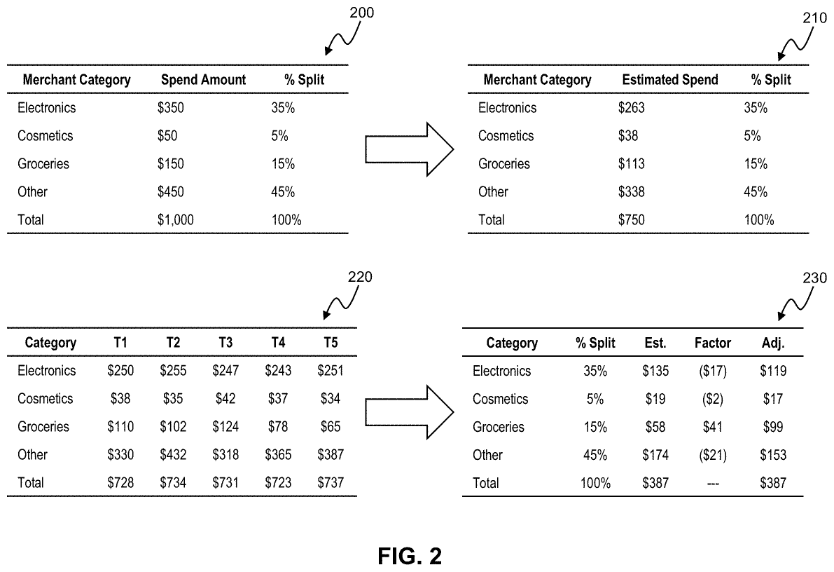

FIG. 2 includes a table 200, which illustrates example spending data that may be received by the processing server 102 from data providers 110. Table 200 illustrates spending data for a specific consumer group, where the spending data includes a spending amount for the consumer group across five different merchant departments. The table 200 also include a percentage of overall spending that can be attributed to each department. In the illustrated example, the spending data may be received from one or more multi-category merchants 106 or may be gathered from merchants 106 of the different departments, or a combination thereof.

In the system 100, a requesting entity 112 may request that the processing server 102 identify spending trends. The requesting entity 112 may be a merchant 106, research institution, or other entity that may be interested in spending trends involving consumer spending at multi-category merchants. For example, the requesting entity 112 may be a physical retailer interested in identifying attrition to e-commerce competitors. In another example, the requesting entity 112 may sell goods or services in a specific merchant department and may want to identify if a loss of sales can be attributed to a multi-category merchant or is due to less overall spending in that industry. In yet another example, the requesting entity 112 may be an advertising agency interested in finding growth opportunities for multi-category merchants for use in targeting or generating new advertising campaigns. The requesting entity 112 may submit a trend request to the processing server 102 using any suitable communication network and method. The trend request may include at least information specifying a consumer group for which a spending trend is requested. In some embodiments, the trend request may be submitted by a data provider 110 and may be accompanied by the spend data that is to be used to identifying the spending trend(s). In some cases, a trend request may specify multiple consumer groups or may specific criteria for use in identifying specific types of trends, such as specifying a merchant industry, geographic area, period of time, etc. In some instances, a trend request may request the processing server 102 provides a forecast of future consumer spending based on identified trends. The trend request may also include information specifying the transactional data to be considered, such as for a specific merchant 106 (e.g., a competitor multi-category merchant 106), a specific merchant industry, a type of merchant 106 (e.g., e-commerce), etc.

The processing server 102 may be configured to estimate categorical spending for the requested consumer group based on the received spending data. The processing server 102 may first identify transaction data for the requested group of consumers 104, as well as the corresponding spending data, such as illustrated in table 200. The processing server 102 may then identify a subset of the identified transaction data, where the transaction data in the subset is filtered based on the trend request. For example, if the trend request requests spending trends at a specific multi-category merchant 104, the processing server 102 may identify only those transaction data entries that involve that specific-multi department merchant 106 along with the consumers 104 in the group. The processing server 102 may then extrapolate the spending data received from the data providers 110 as applied to the transaction data in the subset to estimate the categorical spending for the requested consumer group for each of the spend categories. The processing server 102 may use any suitable extrapolation method, which may vary depending on the amount of data, type of data, size of microsegments, etc.

FIG. 2 includes table 210, which illustrates an example extrapolation of the spending data of table 200 as applied to a subset of transaction data for a specific multi-category merchant 106 as identified by the processing server 102. In the illustrated example, consumers 106 in the identified consumer group spent $750 at the multi-category merchant (e.g., over the same or an equivalent period of time as used to gather the spending data in table 200). The processing server 102 uses the spending data of the table 200 extrapolated onto the total spending (e.g., as identified in the transaction data) of the consumer group at the multi-category merchant 106 to estimate the categorical spending for each spend category. Thus, in the illustrated example, of the total $750 spent, an estimated $113 was spent on groceries to match the proportional spending as indicated in the table 200.

After the categorical spending has been estimated, the processing server 102 may identify any possible spending trends using the data. In an exemplary embodiment, the processing server 102 may estimate categorical spending for the consumer group across a plurality of different periods of time. For example, the processing server 102 may repeat the extrapolation seen in table 210 across several different periods of time based on the stored transaction data and transaction dates included therein. In some cases, spending data may be received for each period of time and may be extrapolated accordingly. In other cases, a single set of spending data (e.g., as in the table 200) may be received and may be extrapolated across multiple periods of time of transaction data.

Table 220 illustrated in FIG. 2 illustrates an example extrapolation of spending data for transaction data across five separate periods of time. The processing server 102 may use the estimated categorical spending to identify one or more spending trends for the consumer group. A spending trend may be identified based on at least a difference in the estimated categorical spending for a specific spend category across the periods of time. In the illustrated example, the processing server 102 may identify a trend of reduced spending on groceries, as indicated by the reduction between time periods 3 and 4 from spending greater than $100 each period to spending $78 and then $65 in the two subsequent periods.

Once a spending trend has been identified, the processing server 102 may provide at least the spending trend to the requesting entity 112 using a suitable communication network and method. In some cases, the processing server 102 may provide the spending data, estimated categorical spending data, or other data used in the identification of the spending trend. In some instances, the requesting entity 112 may specify (e.g., in the trend request) the level of detail or type of data to accompany the spending trend. In the illustrated example, the processing server 102 may, for instance, inform the requesting entity 112 of an average 32% reduction in spending on groceries.

In some embodiments, the processing server 102 may be configured to forecast future spending for spend categories in a consumer group. In such embodiments, the processing server 102 may utilize any identified spending trends as well as the estimated categorical spending to forecast the spending amount in one or more spend categories for a consumer group. For example, the requesting entity 112 may request a forecast for a future period of time of a predicted categorical spending in a specific merchant department. The processing server 102 may estimate the categorical spending across periods of time, as discussed above, and may use those estimates to predict the spending amount for that same merchant department in the future period of time. Such a prediction may use any type of model that may be applied to the estimated categorical spending data discussed herein, which may vary depending on any spending trends, the industry, the future period of time, the past periods of time, consumer group, etc. For instance, in the illustrated example, a predicted spending amount for electronics in a period of time T6 may be $249 due to the lack of variance in the estimated categorical spending amounts for electronics, while the predicted spending amount in T6 for groceries may be $71 (e.g., average of spending amounts for T4 and T5). The processing server 102 may make the forecast and may electronically transmit the forecasted spending amount to the requesting entity 112 in addition to, or in place of, identified spending trends.

In some embodiments, the processing server 102 may be configured to perform adjustments to estimates to account for spending trends or any potential anomalies in estimated categorical spending. For instance, table 230 in FIG. 2 illustrates an example estimation of categorical spending during a period of time T6 following the estimations of table 220. As illustrated in table 230, the amount estimated for spending in groceries may be $58 when the total amount spent at the multi-category merchant 106 is $387. In some instances, the processing server 102 may apply an adjustment factor to adjust the estimated categorical spending amount due to the identified spending trend (e.g., the sudden 32% decrease in grocery spending). For example, the table 220 may indicate spending data at a physical retailer, where the reduction in grocery spending may be attributable to e-commerce retailers or purchases at a multi-category merchant 106, where the reduction may not occur at the multi-category merchant 106 (e.g., due to the consumer 106 shopping there instead). As such, the adjustment factor may be used to compensate for such changes as evidence by the spending trend.

In the table 230, the adjustment factor may be based on differences in the spending amounts for the periods of time T1 through T3 and the spending amounts for the periods of time T4 and T5, due to the identified spending trend indicating a change of spending between periods T3 and T4. In the illustrated example, the adjustment factor for groceries is a positive $41 due to the reduction in average from $112 to $71. The adjustment factor may then be applied to the estimated categorical spending to adjust the estimations accordingly. In such embodiments, the adjusted estimated amount may be provided to the requesting entity 112. In some cases, the processing server 102 may provide both the initial value and the adjusted estimation. In some instances, the adjusted value may be used in forecasting. In some such instances, the processing server 102 may provide forecasts using both the initial value and adjusted estimation, and may indicate accordingly when providing the forecasts to the requesting entity 112. In some embodiments, the processing server 102 may modify the algorithms and other techniques used to identify and apply adjustment factors based on success of previously identified adjusted estimates. For example, the processing server 102 may receive spending data for period T6 after the period has completed, and may compare the spending data with the estimates and adjusted estimates in table 230, and may modify how the adjustment factor is identified and/or applied accordingly.

In some cases, the processing server 102 may be configured to provide estimated categorical spending and forecasts on an individual account level. In such cases, the processing server 102 may use transaction data for one or more multi-category merchants for a specific transaction account. In some such cases, the transaction data may be anonymized such that the processing server 102 cannot personally identify the associated consumer 104. For example, the processing server 102 may use a hash of the transaction account number that cannot be used to identify the transaction account number, but where the requesting entity 112 may have a mapping of the transaction account number to the hashed value. In some instances, the processing server 102 or other entity in the system 100 may obtain approval of the associated consumer 104 for use of account-level data. In other embodiments, the processing server 102 may perform estimations and forecasts using microsegments. For instance, in the tables 220 and 230, the values may be average values for a plurality of transaction accounts that comprise a microsegment or may be aggregated values across all transaction accounts in a microsegment.

The use of microsegments may be beneficial as the account attributes may ensure the accuracy and applicability of data even when there is little or no overlap between consumers 104 in a consumer group, or when specific consumers 104 may not (e.g., or cannot, as applicable) be identified. For instance, the data providers 110 may identify spending data for a group of consumers 104, while the processing server 102 may receive transaction data for a different group of consumers 104 that are in the same microsegment due to their attributes, where the estimated categorical spending and spending forecasts may be just as applicable due to the shared account attributes. Microsegments may also be beneficial in reducing the likelihood or prevalence of bias. For instance, a merchant 106 from whom data providers 110 gather data may have a very narrow demographic of consumers 104, which has potentially to unfairly skew an estimated categorical spending for a multi-category merchant 106 with a wide consumer base. However, as microsegments are used, the spending data for the narrow demographic of consumers 104 will only be applied to that same demographic of consumers 104 at the multi-category merchant 106, thus reducing the effect of bias.

The methods and systems discussed herein enable the processing server 102 to provide for accurate and effective estimates of categorical spending as well as forecasts of future spending across spend categories at multi-category merchants 106, even in cases where there is no department-specific data to be obtained from that merchant 106. Such estimates and forecasting can be beneficial for merchants 106 that are trying to identify trends that are occurring in their own transactions as well as in their industry, including across factors that may adversely affect their business (e.g., attrition to e-commerce merchants or big box retailers). The use of microsegments can provide for effective and valuable data without sacrificing any consumer privacy or security, thus enabling the processing server 102 to operate in compliance with any rules or regulations that may be applicable. For instance, the processing server 102 could provide account-level estimations for authorized requesting entities 112 while just as easily providing estimations for microsegments for which all consumers are protected. The result is a system 100 where categorical spending estimates and spending forecasts can be quickly and easily identified for multi-category merchants even when department- or product-specific data is unavailable.

### Processing Server

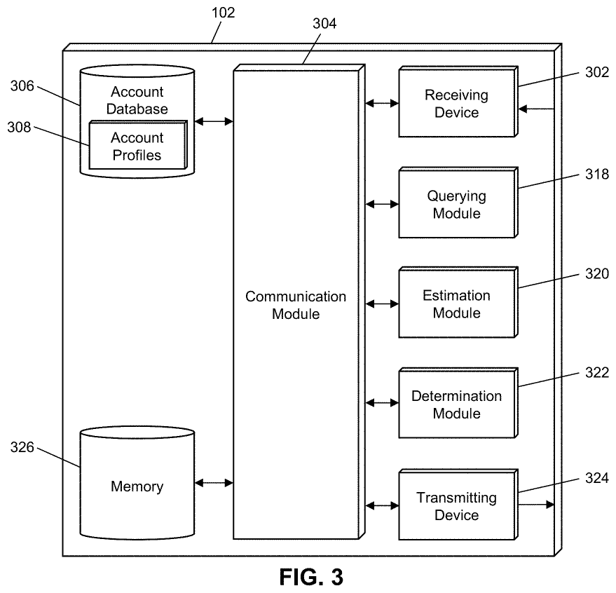

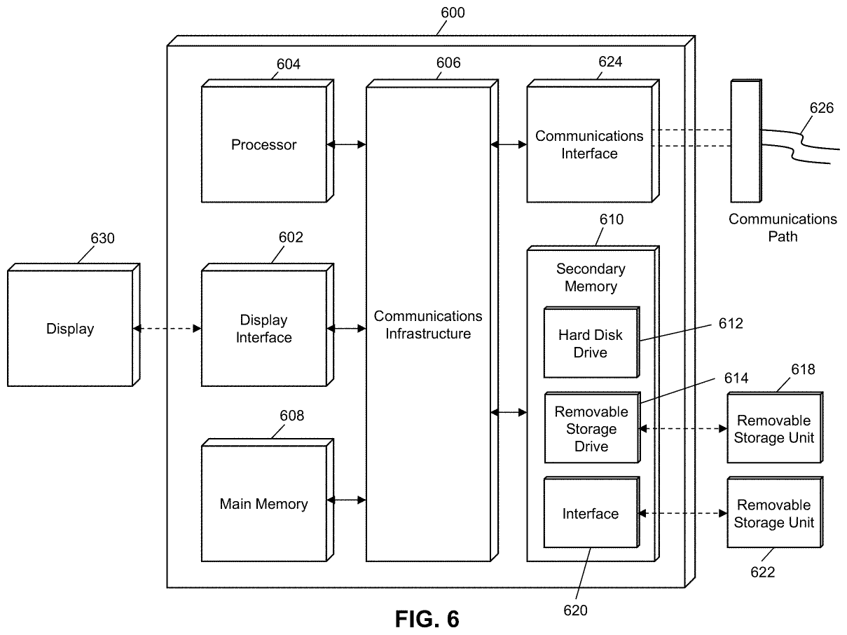

FIG. 3 illustrates an embodiment of a processing server 102 in the system 100. It will be apparent to persons having skill in the relevant art that the embodiment of the processing server 102 illustrated in FIG. 3 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 302. The receiving device 302 may be configured to receive data over one or more networks via one or more network protocols. In some instances, the receiving device 302 may be configured to receive data from merchants 106, payment networks 108, data providers 110, requesting entities 112, and other systems and entities via one or more communication methods, such as radio frequency, local area networks, wireless area networks, cellular communication networks, Bluetooth, the Internet, etc. In some embodiments, the receiving device 302 may be comprised of multiple devices, such as different receiving devices for receiving data over different networks, such as a first receiving device for receiving data over a local area network and a second receiving device for receiving data via the Internet. The receiving device 302 may receive electronically transmitted data signals, where data may be superimposed or otherwise encoded on the data signal and decoded, parsed, read, or otherwise obtained via receipt of the data signal by the receiving device 302. In some instances, the receiving device 302 may include a parsing module for parsing the received data signal to obtain the data superimposed thereon. For example, the receiving device 302 may include a parser program configured to receive and transform the received data signal into usable input for the functions performed by the processing device to carry out the methods and systems described herein.

The receiving device 302 may be configured to receive data signals electronically transmitted by merchants 106 and/or payment networks 108, which may be superimposed or otherwise encoded with transaction data. Transaction data may include data associated with an electronic payment transaction and may include at least a transaction date, transaction amount, and merchant identifier. In some cases, the transaction data may be included in a specially formatted transaction message that is transmitted via payment rails associated with the payment network 108. The receiving device 302 may also be configured to receive data signals electronically transmitted by data providers 110, which may superimposed or otherwise encoded with spending data, which may include spending amounts for a plurality of spend categories for one or more consumer groups, where each consumer group may be associated with at least one account attribute. The receiving device 302 may also be configured to receive data signals electronically transmitted by requesting entities 112, which may be superimposed or otherwise encoded with trend requests, where the trend request may at least specify a consumer group for which a spending trend is requested, and may further include a merchant identifier or merchant category for which a spending trend is requested, a request for forecasted categorical spending amount(s) that may be for a specific period of time and/or spend category, or data to accompany any identified spending trend or forecasted amount.

The processing server 102 may also include a communication module 304. The communication module 304 may be configured to transmit data between modules, engines, databases, memories, and other components of the processing server 102 for use in performing the functions discussed herein. The communication module 304 may be comprised of one or more communication types and utilize various communication methods for communications within a computing device. For example, the communication module 304 may be comprised of a bus, contact pin connectors, wires, etc. In some embodiments, the communication module 304 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 318, estimation module 320, determination module 322, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include an account database 306. The account database 306 may be configured to store a plurality of account profiles 308 using a suitable data storage format and schema. The account database 306 may be a relational database that utilizes structured query language for the storage, identification, modifying, updating, accessing, etc. of structured data sets stored therein. Each account profile 308 may be a structured data set configured to store data related to one or more transaction accounts, such as for an individual transaction account or a microsegment of transaction accounts. An account profile 308 may include, for instance, at least one or more account attributes (e.g., demographic or geographic characteristics or other data used to assign the related transaction account to a microsegment) as well as a plurality of transaction data entries. Each transaction data entry may include transaction data related to a payment transaction involving a related transaction account including at least a transaction date, transaction amount, and merchant identifier. The transaction data may also include any additional data that may be used in performing the functions discussed herein, such as an indication of the payment transaction as being a physical or an e-commerce transaction.

The processing server 102 may include a querying module 318. The querying module 318 may be configured to execute queries on databases to identify information. The querying module 318 may receive one or more data values or query strings, and may execute a query string based thereon on an indicated database, such as the account database 306, to identify information stored therein. The querying module 318 may then output the identified information to an appropriate engine or module of the processing server 102 as necessary. The querying module 318 may, for example, execute a query on the account database 306 to identify a plurality of account profiles 308 for consumers 104 in a consumer group requested by a requesting entity 112, as may be identified based on the included account attribute(s).

The processing server 102 may also include an estimation module 320. The estimation module 320 may be configured to perform estimations for the processing server 102 as part of the functions discussed herein. The estimation module 320 may receive instructions as input, may make an estimation as instructed, and may output the result of the estimation to another module or engine of the processing server 102. In some cases, data to be used in the estimation may be included in the input. In other cases, the estimation module 320 may be configured to identify such data, such as by submitting instructions to the querying module 318 to execute queries to obtain such data. The estimation module 320 may, for example, estimate categorical spending for one or more spend categories for a consumer group based for one or more periods of time based on transaction data for transaction accounts in that consumer group (e.g., based on associated account attributes) including the transaction date and transaction amount included therein.

The processing server 102 may further include a determination module 322. The determination module 322 may be configured to make determinations for the processing server 102 as discussed herein. The determination module 322 may receive instructions as input, may make a determination based thereon, and may output a result of the determination to another module or engine of the processing server 102. In some cases, data to be used in the determination may be included in the input. In other cases, the determination module 322 may be configured to identify such data, such as by submitting instructions to the querying module 318 to execute queries to obtain such data. The determination module 322 may be configured to determine spending trends based on estimates of categorical spending for spend categories over periods of time, based on differences in the spending amounts. The determination module 322 may also be configured to determine forecasts of spending amounts for spend categories for consumer groups, adjustment factors based on estimates of categorical spending, adjusted estimates of spending amounts based on adjustment factors, etc.

The processing server 102 may also include a transmitting device 324. The transmitting device 324 may be configured to transmit data over one or more networks via one or more network protocols. In some instances, the transmitting device 324 may be configured to transmit data to merchants 106, payment networks 108, data providers 110, requesting entities 112, and other entities via one or more communication methods, local area networks, wireless area networks, cellular communication, Bluetooth, radio frequency, the Internet, etc. In some embodiments, the transmitting device 324 may be comprised of multiple devices, such as different transmitting devices for transmitting data over different networks, such as a first transmitting device for transmitting data over a local area network and a second transmitting device for transmitting data via the Internet. The transmitting device 324 may electronically transmit data signals that have data superimposed that may be parsed by a receiving computing device. In some instances, the transmitting device 324 may include one or more modules for superimposing, encoding, or otherwise formatting data into data signals suitable for transmission.

The transmitting device 324 may be configured to electronically transmit data signals to merchants 106, payment networks 108, and data providers 110, which may be superimposed or otherwise encoded with data requests. For instance, the processing server 102 may request transaction data, merchant identifiers, merchant category codes, spending data, consumer group data, account attributes, or other data from merchants 106, payment networks 108, and data providers 110 for use as discussed herein. The transmitting device 324 may also be configured to electronically transmit data signals to requesting entities 112, which may be superimposed or otherwise encoded with responses to trend requests, which may include identified spending trends, data used in the identification thereof, estimated categorical spending, forecasted estimates of future spending, adjusted estimates, etc.

The processing server 102 may also include a memory 326. The memory 326 may be configured to store data for use by the processing server 102 in performing the functions discussed herein, such as public and private keys, symmetric keys, etc. The memory 326 may be configured to store data using suitable data formatting methods and schema and may be any suitable type of memory, such as read-only memory, random access memory, etc. The memory 326 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 326 may be comprised of or may otherwise include a relational database that utilizes structured query language for the storage, identification, modifying, updating, accessing, etc. of structured data sets stored therein. The memory 326 may be configured to store, for example, estimation algorithms, merchant department codes, merchant category codes, microsegment attributes, etc.

### Reporting of Spending Trends Based on Extrapolated Spend Data

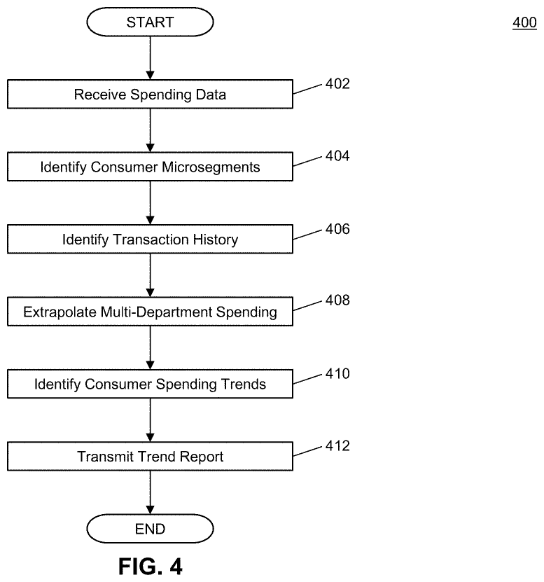

FIG. 4 illustrates an example process 400 executed by the processing server 102 of FIG. 3 in the system 100 of FIG. 1 for the reporting of spending trends identified for a multi-category merchant based on the extrapolation of spend data to transactional data associated therewith.

In step 402, the receiving device 302 of the processing server 102 may receive spending data from one or more data providers 110. The spending data may include at least a spending amount for each of a plurality of different spend categories for one or more consumer groups. Each consumer group may be associated with at least one account attribute, such as a geographic or demographic characteristics or other categorical criteria that may be attributed to a transaction account or to a consumer 104 associated therewith. In step 404, the querying module 318 of the processing server 102 may execute a query on the account database 306 of the processing server 102 to identify a consumer microsegment for each of the consumer groups. Each consumer microsegment may be comprised of the account profiles 308 related to transaction accounts that match, based on the data included in the respective account profile 308, the account attributes included in the respective consumer group.

In step 406, the querying module 318 of the processing server 102 may execute a query on the account profiles 308 included in each consumer microsegment to identify transaction data for payment transactions involving the related transaction account. In some instances, the transaction data may only be identified for transactions involving a specific merchant 106 or that may be filtered based on other criteria (e.g., only e-commerce transactions, transactions at a certain time of data, transactions using a specific currency, transactions in a specified geographic area, etc.). In some such instances, the criteria may be included in a trend request that is received from a requesting entity 112. In step 408, the estimation module 320 may be configured to extrapolate the received spending data to estimate categorical spending for each consumer group for each of the spending categories over a plurality of periods of time, based on the transaction dates and transaction times included in each of the identified transaction data entries as well as the spending amounts included in the spending data.

In step 410, the determination module 322 of the processing server 102 may determine one or more consumer spending trends based on the estimated categorical spending amounts determined for each spend category for each of the consumer groups. A spending trend may be identified by at least a difference in the categorical spending amounts for a spend category between two periods of time. In step 412, the processing server 102 may generate a report of the identified spending trend(s), which may include the trend itself and may include any additional data that may be requested by the requesting entity 112 (e.g., specified in the trend request). The transmitting device 324 of the processing server 102 may electronically transmit the trend report to the requesting entity 112 using a suitable communication network and method.

### Exemplary Method for Identifying Spending Trends at Multi-Category Merchants

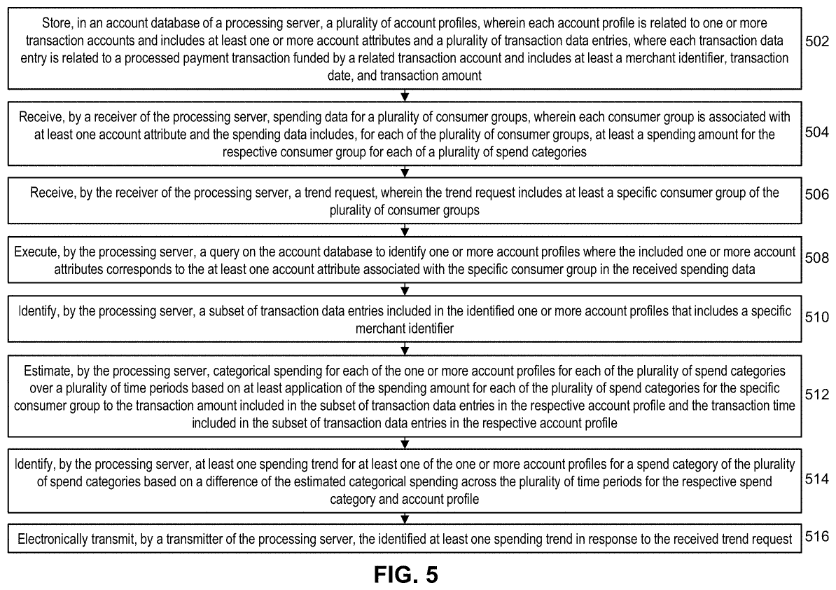

FIG. 5 illustrates a method 500 for the identification of spending trends based on estimated categorical spending determined based on a combination of spending data and historical transactional data.

In step 502, a plurality of account profiles (e.g., account profiles 308) may be stored in an account database (e.g., the account database 306) of a processing server (e.g., the processing server 102), wherein each account profile is related to one or more transaction accounts and includes at least one or more account attributes and a plurality of transaction data entries, where each transaction data entry is related to a processed payment transaction funded by a related transaction account and includes at least a merchant identifier, transaction date, and transaction amount. In step 504, spending data may be received by a receiver (e.g., the receiving device 302) of the processing server for a plurality of consumer groups, wherein each consumer group is associated with at least one account attribute and the spending data includes, for each of the plurality of consumer groups, at least a spending amount for the respective consumer group for each of a plurality of spend categories.

In step 506, a trend request may be received by the receiver of the processing server, wherein the trend request includes at least a specific consumer group of the plurality of consumer groups. In step 508, a query may be executed by the processing server (e.g., via the querying module 318 thereof) on the account database to identify one or more account profiles where the included one or more account attributes corresponds to the at least one account attribute associated with the specific consumer group in the received spending data.

In step 510, a subset of transaction data entries included in the identified one or more profiles that includes a specific merchant identifier may be identified by the processing server. In step 512, categorical spending may be estimated by the processing server (e.g., via the estimation module 320 thereof) for each of the one or more account profiles for each of the plurality of spend categories over a plurality of time periods based on at least application of the spending amount for each of the plurality of spend categories for the specific consumer group to the transaction amount included in the subset of transaction data entries in the respective account profile and the transaction time included in the subset of transaction data entries in the respective account profile.

In step 514, at least one spending trend may be identified by the processing server for at least one of the one or more account profiles for a spend category of the plurality of spend categories based on a difference of the estimated categorical spending across the plurality of time periods for the respective spend category and account profile. In step 516, the identified at least one spending trend may be electronically transmitted by a transmitter (e.g., the transmitting device 324) of the processing server in response to the received trend request.

In one embodiment, the method 500 may further include forecasting, by the processing server (e.g., via the determination module 322 thereof), a future spending amount for the at least one of the one or more account profiles and the spend category of the plurality of spend categories based on the identified at least one spending trend, estimated categorical spending for the respective spend category, and spending amount for the respective spend category, wherein the forecasted future spending amount is electronically transmitted with the identified at least one spending trend. In some embodiments, the method 500 may also include identifying, by the processing server, an adjusted categorical spend amount for the spend category of the plurality of spend categories for the at least one account profile based on application of an adjustment factor to the estimated categorical spending for the respective account profile and respective spend category of the plurality of periods of time, wherein

The identified adjusted categorical spend amount is electronically transmitted with the identified at least one spending trend. In a further embodiment, the method 500 may even further include determining, by the processing server, the adjustment factor based on the difference of the estimated categorical spending across the plurality of time periods for the respective spend category and account profile.

In one embodiment, the spending amount for each consumer group for each of the plurality of spend categories may be an amount of spending at a specific multi-category merchant. In some embodiments, the trend request may further include the specific merchant identifier. In one embodiment, the specific merchant identifier may be indicative of a multi-category merchant. In some embodiments, the spending data may be based on spending for the plurality of consumer groups at a physical merchant and the specific merchant identifier may be indicative of an e-commerce merchant.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 4 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for identifying spending trends at multi-category merchants. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying spending trends at multi-category merchants, comprising:
storing, in an account database of a processing server, a plurality of account profiles, wherein each account profile is related to one or more transaction accounts and includes at least one or more account attributes and a plurality of transaction data entries, where each transaction data entry is related to a processed payment transaction funded by a related transaction account and includes at least a merchant identifier, transaction date, and transaction amount;
receiving, by a receiver of the processing server, spending data for a plurality of consumer groups, wherein each consumer group is associated with at least one account attribute and the spending data includes, for each of the plurality of consumer groups, at least a spending amount for the respective consumer group for each of a plurality of spend categories;
receiving, by the receiver of the processing server, a trend request, wherein the trend request includes at least a specific consumer group of the plurality of consumer groups;
executing, by the processing server, a query on the account database to identify one or more account profiles where the included one or more account attributes corresponds to the at least one account attribute associated with the specific consumer group in the received spending data;
identifying, by the processing server, a subset of transaction data entries included in the identified one or more account profiles that includes a specific merchant identifier;
estimating, by the processing server, categorical spending for each of the one or more account profiles for each of the plurality of spend categories over a plurality of time periods based on at least application of the spending amount for each of the plurality of spend categories for the specific consumer group to the transaction amount included in the subset of transaction data entries in the respective account profile and the transaction time included in the subset of transaction data entries in the respective account profile;
identifying, by the processing server, at least one spending trend for at least one of the one or more account profiles for a spend category of the plurality of spend categories based on a difference of the estimated categorical spending across the plurality of time periods for the respective spend category and account profile; and
electronically transmitting, by a transmitter of the processing server, the identified at least one spending trend in response to the received trend request.

2. The method of claim 1, further comprising:
forecasting, by the processing server, a future spending amount for the at least one of the one or more account profiles and the spend category of the plurality of spend categories based on the identified at least one spending trend, estimated categorical spending for the respective spend category, and spending amount for the respective spend category, wherein
the forecasted future spending amount is electronically transmitted with the identified at least one spending trend.

3. The method of claim 1, further comprising:
identifying, by the processing server, an adjusted categorical spend amount for the spend category of the plurality of spend categories for the at least one account profile based on application of an adjustment factor to the estimated categorical spending for the respective account profile and respective spend category of the plurality of periods of time, wherein
the identified adjusted categorical spend amount is electronically transmitted with the identified at least one spending trend.

4. The method of claim 3, further comprising:
determining, by the processing server, the adjustment factor based on the difference of the estimated categorical spending across the plurality of time periods for the respective spend category and account profile.

5. The method of claim 1, wherein the spending amount for each consumer group for each of the plurality of spend categories is an amount of spending at a specific multi-category merchant.

6. The method of claim 1, wherein the trend request further includes the specific merchant identifier.

7. The method of claim 1, wherein the specific merchant identifier is indicative of a multi-category merchant.

8. The method of claim 1, wherein the spending data is based on spending for the plurality of consumer groups at a physical merchant and the specific merchant identifier is indicative of an e-commerce merchant.

9. A system for identifying spending trends at multi-category merchants, comprising:
an account database of a processing server configured to store a plurality of account profiles, wherein each account profile is related to one or more transaction accounts and includes at least one or more account attributes and a plurality of transaction data entries, where each transaction data entry is related to a processed payment transaction funded by a related transaction account and includes at least a merchant identifier, transaction date, and transaction amount;
a receiver of the processing server configured to receive
spending data for a plurality of consumer groups, wherein each consumer group is associated with at least one account attribute and the spending data includes, for each of the plurality of consumer groups, at least a spending amount for the respective consumer group for each of a plurality of spend categories, and
a trend request, wherein the trend request includes at least a specific consumer group of the plurality of consumer groups;
the processing server configured to
execute a query on the account database to identify one or more account profiles where the included one or more account attributes corresponds to the at least one account attribute associated with the specific consumer group in the received spending data,
identify a subset of transaction data entries included in the identified one or more account profiles that includes a specific merchant identifier,
estimate categorical spending for each of the one or more account profiles for each of the plurality of spend categories over a plurality of time periods based on at least application of the spending amount for each of the plurality of spend categories for the specific consumer group to the transaction amount included in the subset of transaction data entries in the respective account profile and the transaction time included in the subset of transaction data entries in the respective account profile, and
identify at least one spending trend for at least one of the one or more account profiles for a spend category of the plurality of spend categories based on a difference of the estimated categorical spending across the plurality of time periods for the respective spend category and account profile; and
a transmitter of the processing server configured to electronically transmit the identified at least one spending trend in response to the received trend request.

10. The system of claim 9, wherein
the processing server is further configured to forecast a future spending amount for the at least one of the one or more account profiles and the spend category of the plurality of spend categories based on the identified at least one spending trend, estimated categorical spending for the respective spend category, and spending amount for the respective spend category, and
the forecasted future spending amount is electronically transmitted with the identified at least one spending trend.

11. The system of claim 9, wherein
the processing server is further configured to identify an adjusted categorical spend amount for the spend category of the plurality of spend categories for the at least one account profile based on application of an adjustment factor to the estimated categorical spending for the respective account profile and respective spend category of the plurality of periods of time, and
the identified adjusted categorical spend amount is electronically transmitted with the identified at least one spending trend.

12. The system of claim 11, wherein the processing server is further configured to determine the adjustment factor based on the difference of the estimated categorical spending across the plurality of time periods for the respective spend category and account profile.

13. The system of claim 9, wherein the spending amount for each consumer group for each of the plurality of spend categories is an amount of spending at a specific multi-category merchant.

14. The system of claim 9, wherein the trend request further includes the specific merchant identifier.

15. The system of claim 9, wherein the specific merchant identifier is indicative of a multi-category merchant.

16. The system of claim 9, wherein the spending data is based on spending for the plurality of consumer groups at a physical merchant and the specific merchant identifier is indicative of an e-commerce merchant.
